(19) United States
(12) Patent Application Publication
(10) Pub. No.: US 2008/0032584 A1
(43) Pub. Date: Feb. 7, 2008

(54) FABRICATION METHOD OF NITROGEN DISCHARGE LAMP

(76) Inventors: Masafumi Hashimoto, Tokyo (JP); Kenjirou Toryuu, Tokyo (JP); Masafumi Jinno, Ehime (JP); Hideki Motomura, Ehimp (JP); Tatsuya Matsuda, Ehime (JP); Tsuyoshi Sato, Ehime (JP)

Correspondence Address: HAYES SOLOWAY P.C., 3450 E. SUNRISE DRIVE, SUITE 140, TUCSON, AZ, 85718, US

(21) Appl. No.: 11/777,113

(22) Filed: Jul. 12, 2007

(30) Foreign Application Priority Data
Aug. 1, 2006 (JP) 2006-210012

(51) Int. Cl. H01J 9/38

(52) U.S. Cl. 445/38

(57) ABSTRACT

A method of fabricating a nitrogen discharge lamp includes: a first evacuation step for evacuating the gas in a glass tube, a first gas introduction step for introducing nitrogen gas into the glass tube that has undergone the first evacuation step, a preliminary discharge step for producing electric discharge in the glass tube that has undergone the first gas introduction step, a second evacuation step for evacuating the gas inside the glass tube that has undergone the preliminary discharge step, and a second gas introduction step for introducing at least nitrogen gas and a noble gas into the glass tube that has undergone the second gas introduction step.

This application is based upon and claims the benefit of priority from Japanese Patent Application No. 2006-210012, filed on Aug. 1, 2006, the disclosure of which is incorporated herein in its entirety by reference.

### BACKGROUND OF THE INVENTION

1. Field of the Invention

The present invention relates to a method of fabricating a nitrogen discharge lamp that uses nitrogen as a source for generating ultraviolet rays that excite a fluorescent material.

2. Description of the Related Art

In related discharge lamps, an noble gas such as helium (He), neon (Ne), argon (Ar), or xenon (Xe) and a minute amount of mercury are sealed within a glass tube, the inner surfaces of which have been coated with fluorescent material. The application of a high electric field (high frequency) across electrodes provided at the two ends of the glass tube produces a discharge in the mercury vapor. The mercury that has been excited by the discharge emits ultraviolet rays upon transitioning to the normal state, and the fluorescent material is excited by the emitted ultraviolet rays and gives off visible light.

However, increasing concern for environmental issues in recent years has resulted in increased demand for the development of discharge lamps that do not use mercury (mercury-free discharge lamps). More specifically, discharge lamps that use xenon as an ultraviolet source (xenon discharge lamps) have been put into practical use. However, xenon discharge lamps have the problem that luminous efficiency is lower than discharge lamps that take mercury as an ultraviolet ray source (mercury discharge lamp), and further, are prone to discharge contraction. As a result, nitrogen is attracting attention as a new ultraviolet ray source (Refer to Reference Documents 1 and 2).

Reference Document 1: Takubo Shuji, et al. “The development of mercury-free liquid crystal backlights using nitrogen,” Research papers announced at workshop organized by the Institute of Electrical Engineers of Japan (Jan. 27, 2005).

Reference Document 2: Kawashima Yasutaka et al. “Investigation of the use of nitrogen discharge in fluorescent lamps,” Collected papers of the 37^{th} Annual Conference of the Illuminating Engineering Institution of Japan.

Although a nitrogen discharge lamp is free of the above-described problem of a xenon discharge lamp, such a lamp has a different problem in that the nitrogen within the glass tube decreases in proportion to the discharge time, eventually resulting in defective lighting. Although the problem of defective lighting resulting from depletion of mercury also exists for mercury discharge lamps, the continuous lighting time until a nitrogen discharge lamp experiences defective lighting due to depletion of nitrogen is shorter than the continuous lighting time until a mercury discharge lamp experiences defective lighting due to depletion of mercury. In other words, a nitrogen discharge lamp has a shorter service life than a mercury discharge lamp.

However, although the amount of nitrogen inside the glass tube of a nitrogen discharge lamp that has experienced defective lighting can be confirmed to have diminished compared to before the start of lighting, the actual mechanism for this decrease in the amount of nitrogen is not fully understood.

### SUMMARY OF THE INVENTION

It is an object of the present invention to provide a nitrogen discharge lamp that can realize lighting time equal to or greater than that of a mercury discharge lamp.

As the result of repeated investigations to achieve the above-described object, the inventors of the present invention succeeded in finding that nitrogen that is enclosed in a glass tube is absorbed into the tube walls of the glass tube during lighting and thus decreases, leading to the eventual defective lighting of the lamp. The inventors have further found that, in contrast to mercury, nitrogen must be enclosed within the glass tube in a gaseous state, and the amount of enclosed nitrogen is therefore less than mercury from the outset, and this factor contributes to the shorter service life that also results from absorption into the tube walls.

The present invention was achieved based on the above-described findings. The present invention achieves longer service life of a nitrogen discharge lamp by causing nitrogen to be absorbed into the tube walls of a glass tube in advance to prevent the absorption of nitrogen during lighting.

The fabrication method of the nitrogen discharge lamp of the present invention is a fabrication method of a nitrogen discharge lamp in which electrodes are arranged at both ends of a glass tube in which at least nitrogen gas and an noble gas are enclosed, and includes: (1) a first evacuation step for evacuating gas within the glass tube; (2) a first gas introduction step for introducing nitrogen gas into the glass tube that has undergone the first evacuation step; (3) a preliminary discharge step for producing discharge in the glass tube that has undergone the first gas introduction step; (4) a second evacuation step for evacuating gas within the glass tube that has undergone the preliminary discharge step; and (5) a second gas introduction step for introducing at least nitrogen gas and an noble gas into the glass tube that has undergone the second evacuation step.

In the first gas introduction step, a mixed gas of nitrogen gas and noble gas can also be introduced. At least one of the first evacuation step and second evacuation step is preferably carried out while heating the glass tube. At least one of the first gas introduction step and second gas introduction step is preferably carried out after lowering the temperature of the heated glass tube to normal temperature.

The preliminary discharge step is preferably carried out by applying voltage across the pair of electrodes in which at least one of the electrodes has been arranged outside the glass tube. The first gas introduction step and preliminary discharge step are preferably repeated a plurality of times as necessary.

In the nitrogen discharge lamp that has been fabricated by the fabrication method of a nitrogen discharge lamp of the present invention, the absorption of nitrogen into the glass tube during lighting is prevented, whereby a nitrogen discharge lamp having longer service life than in the related art can be obtained.

The above and other objects, features and advantages of the present invention will become apparent from the following descriptions with reference to the accompanying drawings, which illustrate examples of the present invention.

### BRIEF DESCRIPTION OF THE DRAWINGS

FIG. 1 is a process chart showing an example of the fabrication method of the nitrogen discharge lamp of the present invention;

FIG. 2 is a schematic sectional view showing one step of the fabrication method of the nitrogen discharge lamp of the present invention; and

FIG. 3 is a schematic sectional view showing a step of the fabrication method of the nitrogen discharge lamp of the present invention.

### DETAILED DESCRIPTION OF THE EXEMPLARY EMBODIMENT

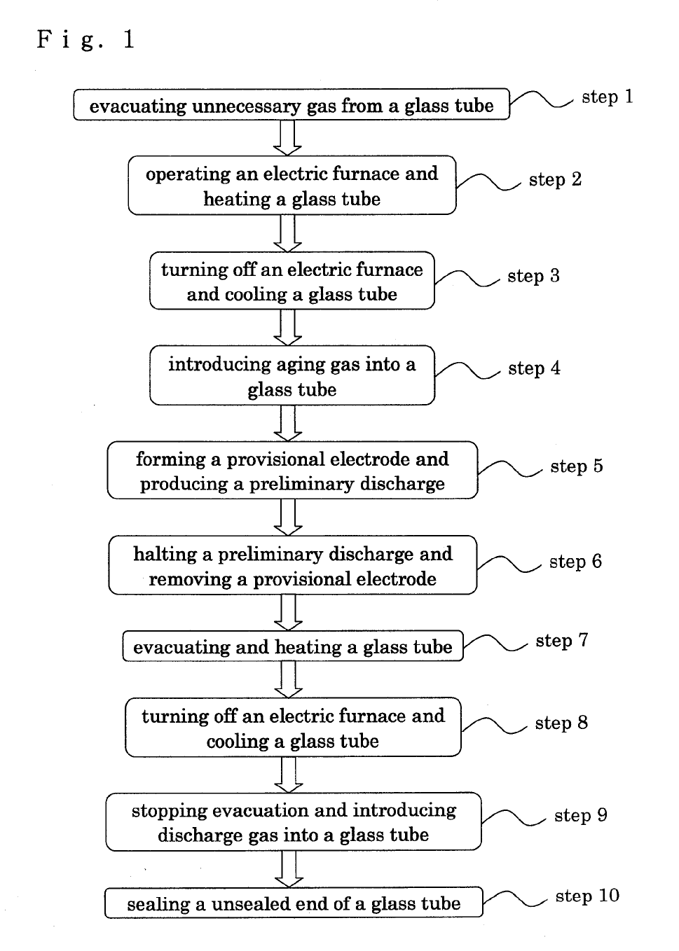

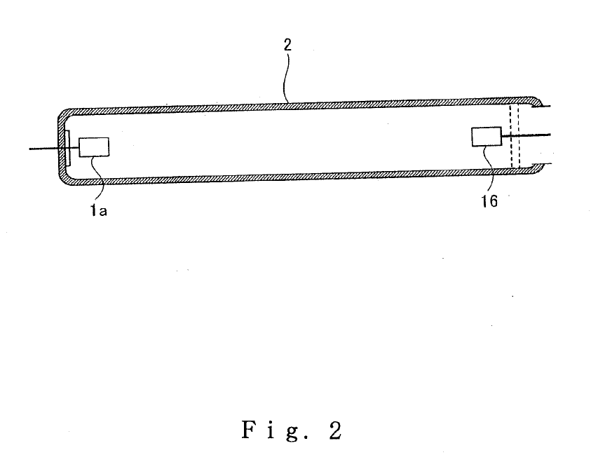

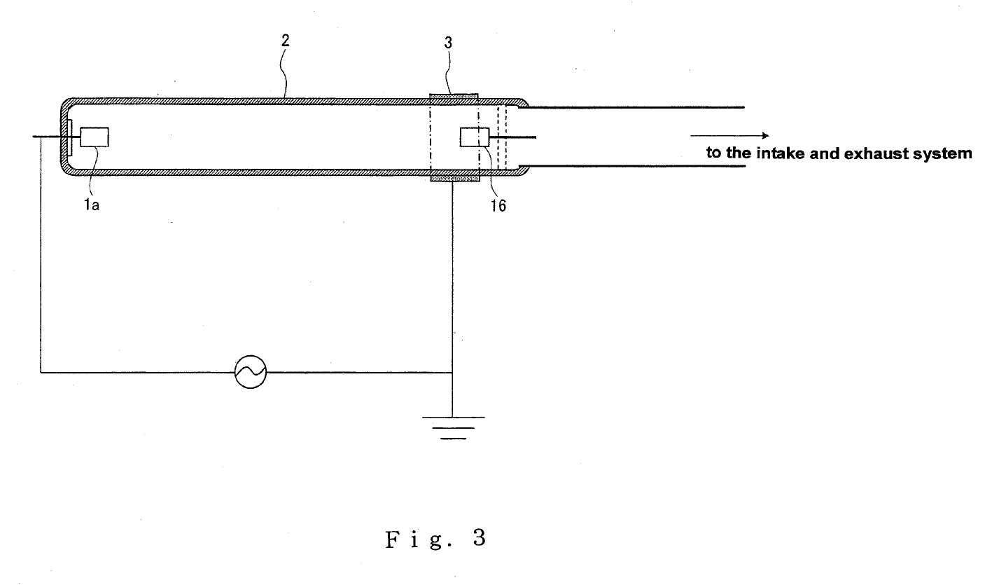

Explanation next regards the details regarding an example of the fabrication method of the nitrogen discharge lamp of the present invention with reference to FIGS. 1 to 3. FIG. 1 is a process chart of the fabrication method of the nitrogen discharge lamp of the present example. FIG. 2 is a schematic sectional view showing a step of the fabrication method of the present example, and FIG. 3 is a schematic sectional view showing another step.

Glass tube 2 is first prepared as shown in FIG. 2 with electrodes 1a and 1b arranged in the interior at the two opposite ends with one end already sealed in an airtight state. In FIG. 2, the left side of glass tube 2 has already been sealed in an airtight state. Electrode 1b arranged on the right side may be only provisionally secured, and the same right end may still be unsealed. In the present explanation, the left end of glass tube 2 that is already sealed at this stage is identified as the “sealed end” and the unsealed right end is identified as the “unsealed end.”

Glass tube 2 shown in FIG. 2 is set in an electric furnace (not shown), and further, the unsealed end of glass tube 2 is connected to an air intake and exhaust system (not shown), whereby unnecessary gas inside glass tube 2 is evacuated (FIG. 1: Step 1). Simultaneous with the start of Step 1, the above-described electric furnace is placed in operation to heat glass tube 2 (FIG. 1: Step 2). In other words, unnecessary gas is evacuated while glass tube 2 is being heated. This heating is for the purpose of volatilizing the unnecessary gas component contained in glass tube 2, glass tube 2 being heated to 450° C. in the present example.

When the temperature of glass tube 2 reaches 450° C., the electric furnace is turned off and glass tube 2 is allowed to cool naturally to normal temperature (room temperature) (FIG. 1: Step 3). The intake and exhaust system is then switched to gas supply, and a mixed gas (aging gas) of argon (Ar) and nitrogen (N₂) is introduced into glass tube 2 from the unsealed end (FIG. 1: Step 4). In the present example, a mixed gas in which Ar:N₂=9:1 is introduced to 20 [Torr] (≈2.666×10³ [Pa]).

Next, as shown in FIG. 3, provisional electrode 3 is formed near the unsealed end of glass tube 2 into which a prescribed amount of aging gas has been introduced. In the present example, aluminum foil is wrapped around the outside of glass tube 2 to form provisional electrode 3. A high-frequency voltage is then applied across provisional electrode 3 and electrode l a that is arranged at the sealed end of glass tube 2 to produce a discharge (preliminary discharge) inside glass tube 2 (FIG. 1: Step 5). In the present example, a high-frequency voltage is applied continuously over four hours.

After the passage of a prescribed time interval, the application of voltage between electrode la and provisional electrode 3 is halted and provisional electrode 3 is removed (FIG. 1: Step 6). The intake and exhaust system connected to the unsealed end of glass tube 2 is then again switched to exhaust, and the electric furnace is again placed in operation while the interior of glass tube 2 is being evacuated to heat glass tube 2 to a prescribed temperature (in the present example, 450° C.) (FIG. 1: Step 7). When the temperature of glass tube 2 reaches the prescribed temperature (in the present example, 450° C.), the electric furnace is turned off and glass tube 2 is allowed to naturally cool to normal temperature (room temperature) (FIG. 1: Step 8).

After the temperature of glass tube 2 has fallen to normal temperature, the intake and exhaust system is switched to a gas supply and a mixed gas (discharge gas) of argon (Ar) and nitrogen (N₂) is introduced into glass tube 2 (FIG. 1: Step 9), following which the unsealed end of glass tube 2 is sealed in an airtight state (FIG. 1: Step 10).

The method of evacuating glass tube 2 and the method of introducing the aging gas and discharge gas into glass tube 2 are equivalent to methods used in the related art, and explanation of these methods is therefore here omitted. The method of sealing the unsealed end is equivalent to methods used in the related art, and explanation of the method is therefore here omitted.

The nitrogen discharge lamp is completed by means of the procedures described hereinabove. Lighting tests carried out for the completed nitrogen discharge lamp confirmed that the continuous lighting time was longer than for a nitrogen discharge lamp of the related art. In addition, examination of a section of the tube walls of the glass tube after continuous lighting confirmed the presence of nitrides on the inner surface and within a range of depth of from several nm to ten and several nm from the inner surface. Based on these phenomena, it is believed that the absorption of nitrogen into the glass tube due to the above-described preliminary discharge prevents the absorption of nitrogen into the glass tube during lighting, whereby a lengthening of lighting time was obtained.

Further, although the step of applying a fluorescent material to the inner surface of glass tube 2 was omitted in the previous explanation and in FIG. 1, a fluorescent material was applied to the inner surface of glass tube 2 at an appropriate stage.

In the specification, explanation regarded a case in which a mixed gas of nitrogen gas and argon gas is used as the aging gas and discharge gas, but the noble gas that is mixed with nitrogen gas is not limited to argon gas and a desired noble gas such as neon gas or helium gas can also be selected. In addition, a mixed gas in which two or more types of noble gas are mixed can also be used. Still further, the aging gas may be only nitrogen gas.

Although a nitrogen discharge lamp of the internal electrode type was described as an example of an embodiment of the present invention in the present specification, the fabrication method of the present invention can also be applied to a nitrogen discharge lamp of the external electrode type. In such a case, a provisional electrode need not be provided for the preliminary discharge, and a high-frequency voltage can be applied across a pair of external electrodes provided on the exterior of the glass tube (on the surface of the outer circumference) to produce the preliminary discharge. Of course, a provisional electrode may also be provided and a high-frequency voltage may then be applied across this provisional electrode and the other external electrode to produce the preliminary discharge.

Still further, the introduction of aging gas and the preliminary discharge may be repeated a plurality of times as necessary. For example, a series of cycles can be repeated in which, after carrying out the preliminary discharge for a prescribed time interval, the interior of the glass tube is evacuated, the aging gas again introduced, and the application of voltage resumed.

Alternatively, a series of cycles can be repeated in which the current and the voltage across the electrodes during the preliminary discharge are monitored, and upon decrease of the voltage below a prescribed value (or rise of the current above a prescribed value), the interior of the glass tube is evacuated, the aging gas again introduced, and the application of voltage resumed. Because the aging gas (nitrogen gas) is absorbed into the glass tube by the preliminary discharge and thus decreases, two or more introductions of aging gas brings about the absorption of a sufficient amount of nitrogen into the glass tube and can therefore realize more effective and more reliable prevention of the absorption of nitrogen into the glass tube during lighting.

In this case, the decrease of the voltage across the electrodes (increase in current) during the preliminary discharge indicates a state in which the amount of nitrogen in the glass tube has decreased and in which the production of discharge has become easier. Accordingly, controlling the timing or the number of instances of the reintroduction of aging gas based on the voltage across the electrodes (the current) in the preliminary discharge is extremely effective as a method for bringing about absorption of a sufficient amount of nitrogen into the glass tube.

While a preferred embodiment of the present invention has been described using specific terms, such description is for illustrative purposes only, and it is to be understood that changes and variations may be made without departing from the spirit of scope of the following claims.

What is claimed is:

1. A fabrication method of a nitrogen discharge lamp for fabricating a nitrogen discharge lamp in which electrodes are arranged at the two ends of a glass tube in which at least nitrogen gas and an noble gas are enclosed, said fabrication method comprising:
a first evacuation step for evacuating gas within said glass tube;
a first gas introduction step for introducing nitrogen gas into said glass tube that has undergone said first evacuation step;
a preliminary discharge step for producing discharge in said glass tube that has undergone said first gas introduction step;
a second evacuation step for evacuating gas within said glass tube that has undergone said preliminary discharge step; and
a second gas introduction step for introducing at least nitrogen gas and an noble gas into said glass tube that has undergone said second evacuation step.

2. A fabrication method of a nitrogen discharge lamp for fabricating a nitrogen discharge lamp in which electrodes are arranged at the two ends of a glass tube in which at least nitrogen gas and an noble gas are enclosed, said fabrication method comprising:
a first evacuation step for evacuating gas within said glass tube;
a first gas introduction step for introducing a mixed gas of nitrogen gas and an noble gas into said glass tube that has undergone said first evacuation step;
a preliminary discharge step for producing a discharge in said glass tube that has undergone said first gas introduction step;
a second evacuation step for evacuating gas within said glass tube that has undergone said preliminary discharge step; and
a second gas introduction step for introducing at least nitrogen gas and an noble gas into said glass tube that has undergone said second evacuation step.

3. The fabrication method of a nitrogen discharge lamp according to claim 1, wherein at least one of said first evacuation step and said second evacuation step is carried out while heating said glass tube.

4. The fabrication method of a nitrogen discharge lamp according to claim 2, wherein at least one of said first evacuation step and said second evacuation step is carried out while heating said glass tube.

5. The fabrication method of a nitrogen discharge lamp according to claim 1, wherein said preliminary discharge step is carried out by applying voltage across a pair of electrodes at least one of which is arranged outside said glass tube.

6. The fabrication method of a nitrogen discharge lamp according to claim 2, wherein said preliminary discharge step is carried out by applying voltage across a pair of electrodes at least one of which is arranged outside said glass tube.

7. The fabrication method of a nitrogen discharge lamp according to claim 1, wherein said first gas introduction step and said preliminary discharge step are repeated a plurality of times.

8. The fabrication method of a nitrogen discharge lamp according to claim 2, wherein said first gas introduction step and said preliminary discharge step are repeated a plurality of times.

9. The fabrication method of a nitrogen discharge lamp according to claim 3, wherein at least one of said first gas introduction step and said second gas introduction step is carried out after the temperature of said glass tube that has been heated is lowered to normal temperature.

10. The fabrication method of a nitrogen discharge lamp according to claim 4, wherein at least one of said first gas introduction step and said second gas introduction step is carried out after the temperature of said glass tube that has been heated is lowered to normal temperature.
